(19) United States
(12) Patent Application Publication
(10) Pub. No.: US 2012/0182136 A1
(43) Pub. Date: Jul. 19, 2012

(54) VEHICLE APPROACH WARNING APPARATUS

(75) Inventors: Toshiaki NAKAYAMA, Miyoshi-city (JP); Koji Suzuki, Kosai-city (JP); Yoshiaki Watanabe, Kosai-city (JP)

(73) Assignees: HAMANAKODENSO CO., LTD., Kosai-city (JP); DENSO CORPORATION, Kariya-city (JP)

(21) Appl. No.: 13/343,870

(22) Filed: Jan. 5, 2012

(30) Foreign Application Priority Data
Jan. 18, 2011 (JP) 2011-7841

(51) Int. Cl. B60Q 1/00

(52) U.S. Cl. 340/425.5

(57) ABSTRACT

A vehicle (approach) warning apparatus generates a warning sound that is emitted from a parametric speaker and a vehicle horn, by driving the vehicle horn with a rectangular wave signal of 0 volts or more, thereby preventing a power loss due to a counter electromotive force that is caused by an alternation of a plus electric voltage and a minus electric voltage in the horn as well as preventing a problematic distortion of the warning sound from the horn. Further, since the vehicle (approach) warning apparatus is devised to prevent the parametric speaker from generating a low pitch sound of 500 Hz that is reproduced by the horn, an influence of a higher harmonic wave upon a reproduced sound from the parametric speaker is reduced, thereby preventing deterioration of a sound from the parametric speaker.

### CROSS REFERENCE TO RELATED APPLICATION

The present application is based on and claims the benefit of priority of Japanese Patent Application No. 2011-7841, filed on Jan. 18, 2011, the disclosure of which is incorporated herein by reference.

### TECHNICAL FIELD

The present disclosure generally relates to a vehicle (approach) warning apparatus that generates a warning sound for warning a pedestrian and the like around the vehicle about the approach of the vehicle.

### BACKGROUND

Vehicles driven by an electric motor may generate little to no sound while traveling. The lack of sound is problematic in that it provides little to no warning of the approaching vehicle to pedestrians or other motorists around the vehicle. A warning device that outputs a sound to notify others that are in the vicinity of the traveling vehicle is disclosed in Japanese Patent Laid-Open No. 2005-289175 (JP '175).

The warning sound disclosed in JP '175 may be heard by people that are within a short-distance of the vehicle, but may not be heard by people that are further away, to whom the vehicle is traveling towards.

Additionally, generating and outputting the warning sound via the dynamic speaker will require the generated sound to have a greater sound pressure value, thereby causing the generated warning sound to have a greater volume, which may be uncomfortable for the occupants of the vehicle.

### SUMMARY

In view of the above and other problems, the present disclosure provides a vehicle (approach) warning apparatus which prevents the tone change of the dynamic speaker and prevents the counter electromotive force generated in the coil of the dynamic speaker for decreasing the electricity consumption of the power amplifier, and, at the same time, prevents the deterioration of the tone of the parametric speaker.

In an aspect of the present disclosure, the vehicle (approach) warning apparatus for notifying the presence of a vehicle, includes a parametric speaker and a dynamic speaker. The parametric speaker emits a supersonic wave that radiates outward from the vehicle. The supersonic wave is generated by performing a supersonic modulation on a warning sound. The dynamic speaker emits an audible-frequency-range warning sound that radiates outward from the vehicle by changing a magnetic field of a coil based on a change of an electric current applied to the coil, wherein the dynamic speaker is driven by a rectangular wave signal of at least zero volts.

In addition to the above configuration, the lowest frequency of the warning sound generated by the dynamic speaker is configured to be higher than the lowest frequency of the warning sound generated by the parametric speaker. In such manner, the influence of harmonics of the low pitch sound frequency can be suppressed in the reproduced sound of the parametric speaker, thereby preventing the deterioration of the tone of the parametric speaker.

As described above, when the dynamic speaker is driven by a rectangular wave signal, such method may be beneficial for the dynamic speaker to reproduce a single sound, but may make it difficult for the dynamic speaker to simultaneously reproduce multiple frequencies.

Therefore, when the dynamic speaker generates a composite sound of multiple frequencies as the warning sound, such warning sound is composed as a composite sound of multiple single sound frequencies, and each of the multiple single sound frequencies is cyclically generated in a certain order for a short cycle.

In such manner, each of the single sound frequencies is superposed with the other frequencies when the output sound reaches the ears of an individual, thereby reproducing a composite sound of multiple frequencies.

In addition to the above configuration, the dynamic speaker in the vehicle (approach) warning apparatus used in a vehicle is an electro-magnetic type vehicular horn that generates an alarm sound or an excitation horn sound when a horn switch is operated by a user of the vehicle.

### BRIEF DESCRIPTION OF THE DRAWINGS

Objects, features, and advantages of the present disclosure will become more apparent from the following detailed description made with reference to the accompanying drawings, in which

FIG. 1 is a block diagram of a vehicle (approach) warning apparatus of the present disclosure;

FIG. 2A is an illustration of the vehicle (approach) warning apparatus in a perspective view;

FIG. 2B is a cross-sectional view of the vehicle (approach) warning apparatus;

FIG. 3 is a diagram of frequency characteristics of a vehicular horn of the vehicle (approach) warning apparatus;

FIGS. 4A and 4B are illustrations of outreach distribution of a warning sound of the vehicle (approach) warning apparatus;

FIG. 5 is an illustration of a rectangular wave signal of each of divided single sound frequencies;

FIG. 6 is a diagram of frequency characteristics of the vehicle (approach) warning apparatus driven by a sine wave signal and by a rectangular wave signal; and

FIG. 7 is a diagram of frequency characteristics of the warning sound from a parametric speaker with and without a 500 Hz frequency sound included therein.

### DETAILED DESCRIPTION

In the following embodiment, the vehicle (approach) warning apparatus is explained with reference to the drawings, without limiting the disclosure to such embodiment. In the embodiment and in its modifications, like numbers show like parts.

(Configuration)

A vehicle in the present embodiment is a quiet vehicle that generates little to no sound when the vehicle is traveling, such as an electric vehicle, hybrid vehicle, or the like. The vehicle is equipped with a vehicle (approach) warning apparatus to notify the surrounding area of the presence and approach of the vehicle by way of a parametric speaker 1 that outputs a supersonic wave and a vehicular horn 3 that is operated as a dynamic speaker.

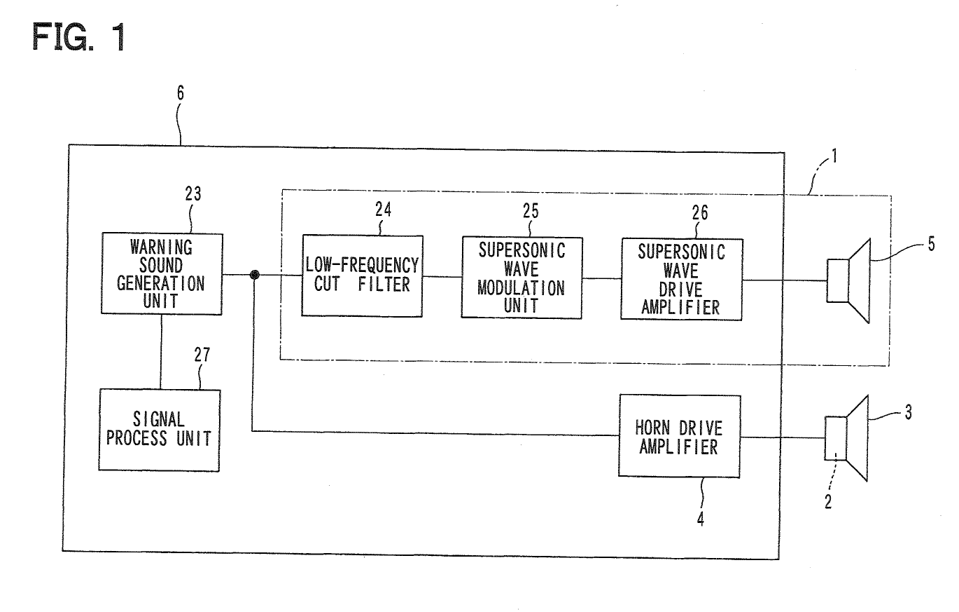

With reference to FIG. 1, the vehicle (approach) warning apparatus is equipped with the vehicular horn 3, a supersonic speaker 5, and a control circuit 6. The vehicular horn 3 may be an electro-magnetic type horn capable of generating a sound, and the supersonic speaker 5 is capable of emitting a supersonic wave that radiates outwards from the vehicle. The control circuit 6 is configured to control the operation of the vehicular horn 3 and the supersonic speaker 5.

(Vehicular Horn 3)

The vehicle, which is equipped with the vehicular horn 3, includes a horn switch or button (not shown) that actuates the vehicular horn 3. The vehicular horn 3 may be installed in a front part of the vehicle. Once the horn switch is engaged, the vehicular horn 3 generates an alarm sound or an excitation horn sound when a self-excitation voltage is above a threshold voltage, such as 8 V or more.

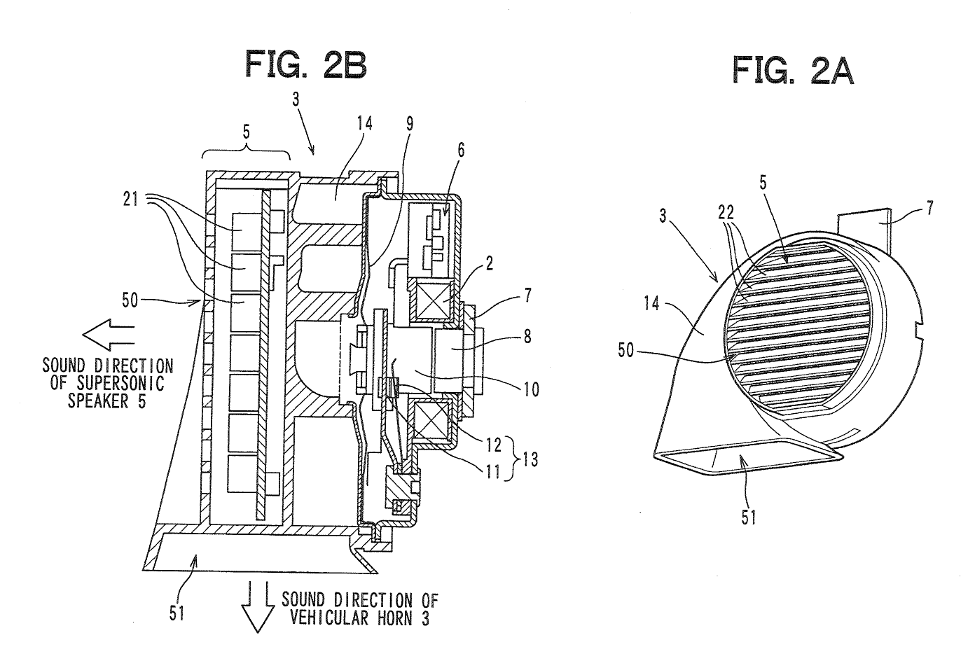

With reference now to FIGS. 2A and 2B, the vehicular horn 3 is installed with a stay 7 in a front part of the vehicle, such as, in front of a radiator (not shown). The vehicular horn 3 includes a coil 2 to generate a magnetic force, a fixed iron core 8, a movable iron core 10, and a movable contact point 12. The fixed iron core 8 outputs an attraction force that is generated as a magnetic force from the coil 2, and may be referred to as a magnetic attraction core.

The movable iron core 10 is supported at the center of a vibration board 9 or a diaphragm. The attraction force provided by the fixed core 8, moves the movable iron core 10 towards the fixed iron core 8, and, as a result, the movable contact point 12 decouples from a fixed contact point 11, which interrupts the electric current supplied to the coil 2.

In particular, the self-excitation voltage is supplied across the coil 2 via power terminals that are coupled to the ends of the coil 2, and a current flows across the coil 2. When the self-excitation voltage is above a threshold (i.e., the voltage is equal to or greater than 8 V), an attracting action and a returning action is repeatedly performed within the vehicular horn 3.

Specifically, in regards to the attracting action, when the current flows through the coil 2, an electromagnetic field is generated and an attraction occurs between the movable iron core 10 and the fixed iron core 8, such that the movable iron core 10 moves towards the fixed iron core 8. Due to the movement of the movable iron core 10 towards the fixed iron core 8, the moveable contact point 12, decouples from the fixed contact point 11, causing the current to stop flowing through the coil 2.

Once, the current has stopped flowing through the coil 2, the electromagnetic field is no longer generated and the moveable iron core 10 returns to its initial position, which is the returning action. Due to the biasing of the movable iron core 10, the movable contact point 12 couples with the fixed contact point 11, and the current resumes flowing through the coil 2, thus restarting the attracting action.

In other words, when the self-excitation voltage is equal to or greater than the threshold voltage the current flows through the coil 2, and an electric current interrupter 13, which allows and prevents the current from flowing through the coil 2, is formed by the fixed contact point 11 and the movable contact point 12.

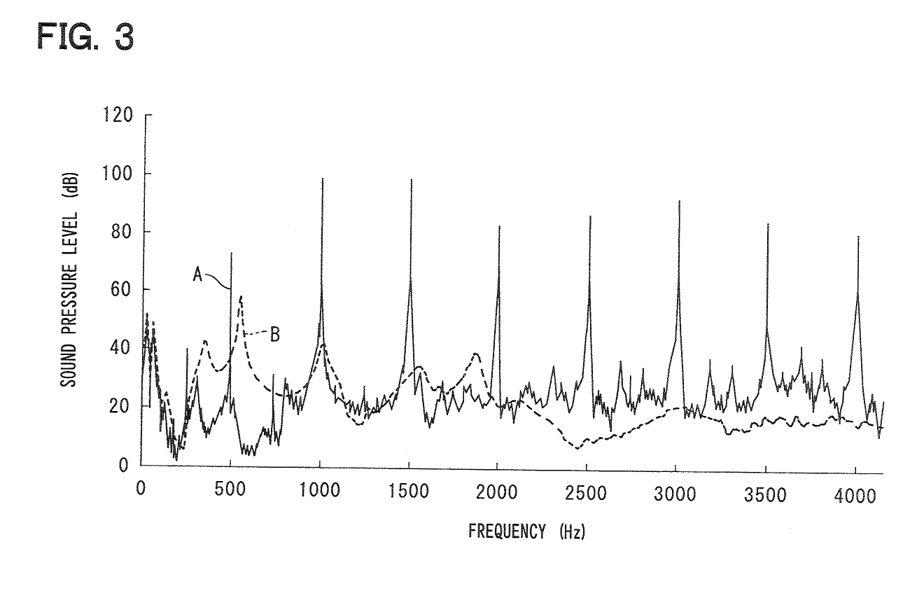

Due to the attracting and returning action, the movable iron core 10 causes a vibration of the vibration board 9, and the vehicular horn 3 generates the excitation horn sound. The vehicular horn 3 generates the excitation horn sound having predetermined frequencies (for example, 500 Hz and the like), one of which serves as a base sound. The frequency characteristics of the excitation horn sound generated when the self-excitation voltage is greater than or equal to 8V by the vehicular horn 3 are shown by a solid line A in FIG. 3.

Further, in the present embodiment, the vehicular horn 3 is used as a dynamic speaker by providing a driving signal of an excitation voltage that is lower than the threshold voltage for the vehicular horn 3, such as an excitation voltage lower than 8 V.

The frequency characteristics of the vehicular horn 3 at a time of using the vehicular horn 3 as a dynamic speaker are shown by a dashed line B in FIG. 3. The dashed line B shows the frequency characteristics when a sweep signal (i.e., a variable signal transiting from a low frequency to a high frequency) of 1 V in a sine wave form is provided for the vehicular horn 3.

The vehicular horn 3 in the present embodiment includes a swirl shape horn 14 (i.e., a trumpet member in a swirling shape: a sound tube in a swirl shape) as shown in FIG. 2A. The swirl shape horn 14 amplifies the sound generated by the vibration of the vibration board 9, and radiates the amplified sound outward from the vehicle to the surrounding area. It would be apparent to one skilled in the art that the vehicular horn 3 is not required to have the swirl shape horn 14.

(Supersonic Speaker 5)

The supersonic speaker 5 is disposed on a side face of the swirl shape horn 14 in the present embodiment, and is configured to emit a supersonic wave that radiates outward from the vehicle, such that the direction of the supersonic wave is projected in a frontal direction of the vehicle. The supersonic speaker 5 is disposed on a front facing side of the horn 14 directed towards the outer surrounding area of the vehicle.

The supersonic speaker 5 is a supersonic wave generator generating air vibration having a frequency that is higher than the human audible range (i.e., greater than 20 kHz).

The supersonic speaker 5 in the present embodiment is disposed as a speaker array of a plurality of piezoelectric speakers 21 that are suitable for supersonic wave reproduction, such as a ceramic speaker, a piezo speaker, or the like. The piezoelectric speakers 21 have a well-known structure including the piezoelectric elements that expand and contract according to the applied voltage (i.e., the voltage from charge and discharge). The expansion and contraction of the piezoelectric elements causes the vibration board 9 to produce air vibration.

Based on the number and the arrangement of the piezoelectric speakers 21, the supersonic speaker 5 can control the amount of energy in the generated supersonic wave, as well as, the directivity range of the supersonic wave output from each of the piezoelectric speakers 21.

The supersonic wave generated by the piezoelectric speakers 21, is emitted through a speaker opening 50. The supersonic speaker 5 includes a device, such as a louver 22, to prevent water or other foreign particles from entering the supersonic speaker 5 by way of the speaker opening 50, while still permitting the transmission of the supersonic wave. Additionally, those skilled in the art will appreciate in view of this disclosure that the louver 22 may be replaced with a mesh element, cover, or the like, which prevents moisture from entering the supersonic speaker 5 while still emitting the supersonic wave.

The louver 22 is arranged so as not to affect the quality of the supersonic wave as it is outputted from the piezoelectric speaker 21. The supersonic wave emitted from each of the piezoelectric speakers 21 is reflected in a downward direction on an inside surface of the louver 22 and then reflected again outward on an outside surface of the louver 22, such that the wave radiates in a frontal direction of the vehicle. Thus, the supersonic wave radiates outwards from a frontal direction of the vehicle.

Additionally, it should be understood, that the speaker opening 50 of the supersonic speaker 5 may be positioned facing another direction other than the front direction of the vehicle. That is, the sound radiation hole may be directed in any direction, such as, the back side of the vehicle, and such directivity of the emitted supersonic wave may be realized by using a reflector or the like.

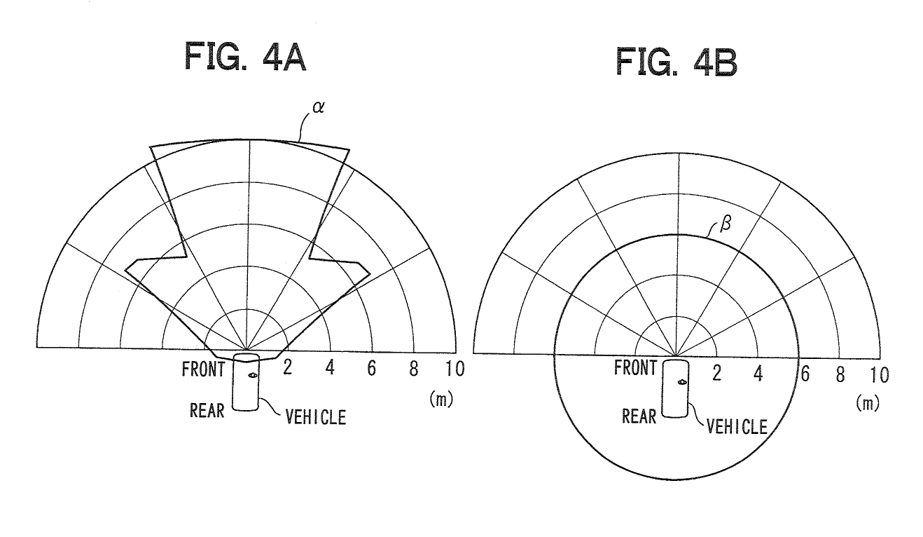

FIG. 4A illustrates a coverage area α of the warning sound from the parametric speaker 1 and FIG. 4B illustrates a coverage area β of the warning sound from the vehicular horn 3. The coverage areas α and β show the areas of the warning sound with its sound pressure measured as 50 dB or more. As described above, the supersonic speaker 5 of the present embodiment is disposed to emit a supersonic wave outward toward a travel direction of the vehicle.

Further, the vehicular horn 3 is arranged to emit the warning sound substantially evenly around the vehicle, as shown in FIG. 4B. A horn opening 51 of the swirl shape horn 14 of the vehicular horn 3, from which the warning sound is emitted, is directed in a downward direction of the vehicle to face the road surface. The direction of the horn opening 51 may also be set to another directions, and such directivity may be realized by using a reflector or the like.

(Control Circuit 6)

As, shown in FIGS. 1 and 2B, the vehicular horn 3 includes the control circuit 6. The control circuit 6 includes:

(a) a horn drive amplifier 4 for driving the vehicular horn 3 according to a warning sound signal,

(b) a warning sound generation unit 23 for generating the warning sound signal,

(c) a low-frequency cut filter 24 for removing a low pitch frequency sound from the warning sound signal,

(d) a supersonic wave modulation unit 25 for modulating the warning sound signal into a signal having the supersonic frequency, from which the low pitch frequency sound is removed,

(e) a supersonic wave drive amplifier 26 for driving the supersonic speaker 5 according to the supersonic modulated signal, and

(f) a signal process unit 27 for controlling the above-described operations.

The above-described elements of the control circuit 6 are explained in the following.

(Horn Drive Amplifier 4)

The horn drive amplifier 4 is a power amplifier that operates the vehicular horn 3 as a dynamic speaker. The horn drive amplifier 4 amplifies a warning sound signal from the warning sound generation unit 23, and outputs the amplified signal to the power terminals coupled to the coil 2 of the vehicular horn 3.

The maximum output of the horn drive amplifier 4 is restricted to 8 V or less, which is provided as the separate excitation voltage, and the voltage output from the horn drive amplifier 4 for generating the warning sound is configured to have a level that will not generate the excitation horn sound from the vehicular horn 3. In other words, when the self-excitation voltage is equal to the separate excitation voltage (i.e. it is lower than 8V), the excitation horn sound is not produced by the vehicular horn 3, but the warning sound generated by the warning sound signal is produced by the vehicular horn 3.

The horn drive amplifier 4 is a class D digital amplifier, or the like, that drives the vehicular horn 3 by a rectangular wave signal. The rectangular wave signal may have of a low voltage (Lo) of 0 V and high voltage (Hi) that is greater than Lo but less than 8V.

The horn drive amplifier 4 generates a duty ratio signal according to an input frequency by using pulse width modulation (PWM), and drives the vehicular horn 3 by amplifying such duty ratio signal. Though PWM is shown as an example of the digital amplifier, other digital amplifiers using the pulse density modulation technology may also be used as the digital amplifier.

The horn drive amplifier 4 has a gain controller (e.g., a volume controller), that is used to set a predetermined sound pressure level of the warning sound from the vehicular horn 3 at a certain distance from the vehicle. That is, for example, the sound pressure of the warning sound from the vehicular horn 3 may be set to 50 dB, at a position of 6 meters from the vehicle (see FIG. 4B).

(Warning Sound Generation Unit 23)

The warning sound generation unit 23 generates a pre-stored warning sound signal (i.e., a signal having audible frequency) according to the information provided from the signal process unit 27.

In the present embodiment, the supersonic wave drive amplifier 26 may be an analogue amplifier (i.e., a push-pull amplifier), which is described in detail further below. The warning sound generation unit 23 of the present embodiment outputs “a warning sound signal” according to an analog signal that has the “+” voltage (i.e., a plus electric current) and the “−” voltage (i.e., a minus electric current) alternating with each other.

In the present embodiment, the warning sound may be a chord sound, or the like, which may not cause uneasiness or unpleasantness to the people around the vehicle, where the warning sound may be a composite sound having multiple frequency components.

Since, the horn drive amplifier 4 drives the vehicular horn 3 by the rectangular wave signal, as described above, the horn drive amplifier 4 is able to generate a single sound according to the rectangular wave signal. However, the horn drive amplifier 4 may not be able to generate the chord sound or another sound that has a composite sound of multiple frequency components according to the rectangular wave signal.

Therefore, the warning sound generation unit 23 of the present embodiment divides the composite sound that has the multiple frequency components into multiple single sound frequencies, and generates each of the single sound frequencies cyclically in a certain order for a short cycle, such as 60 ms, or the like.

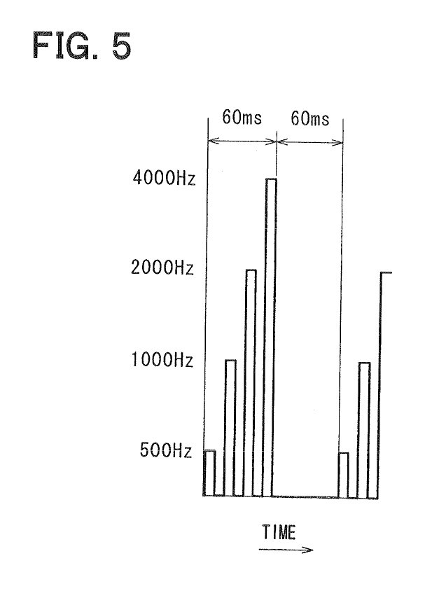

With reference to FIG. 5, a warning sound having frequencies of 500 Hz, 1 kHz, 2 kHz, and 4 kHz is generated in the following example.

The warning sound generation unit 23 generates in a cycle of 60 ms, the frequencies in the following order: 500 Hz, 1 kHz, 2 kHz, and 4 kHz.

Further, in FIG. 5, “the pulse height (i.e., the pulse voltage value or the pulse current value)” increases for the higher frequencies. However, such height difference is for the illustration purpose only, and the actual pulse height is same for all frequencies.

Accordingly, the following occurs:
when the warning sound generation unit 23 generates a frequency of 500 Hz, the horn drive amplifier 4 drives the vehicular horn 3 at the frequency of 500 Hz, and a frequency of 500 Hz is reproduced by the vehicular horn 3,
when the warning sound generation unit 23 generates a frequency of 1 kHz, the horn drive amplifier 4 drives the vehicular horn 3 at the frequency of 1 kHz, and a frequency of 1 kHz is reproduced by the vehicular horn 3,
when the warning sound generation unit 23 generates a frequency of 2 kHz, the horn drive amplifier 4 drives the vehicular horn 3 at the frequency of 2 kHz, and a frequency of 2 kHz is reproduced by the vehicular horn 3, and
when the warning sound generation unit 23 generates a frequency of 4 kHz, the horn drive amplifier 4 drives the vehicular horn 3 at the frequency of 4 kHz, and a frequency of 4 kHz is reproduced by the vehicular horn 3.

One cycle of the above operations is preformed within 60 ms, each of those single sound frequencies is heard substantially at the same time by the human ear. In other words, the warning sound from the vehicular horn 3 sounds like a chord sound that is composed of the frequencies of 500 Hz, 1 kHz, 2 kHz, and 4 kHz.

Further, though 60 ms is used as an example of “a predetermined short cycle” in the present embodiment, such period may be changed to different values, e.g., to 100 ms, 80 ms, or the like, as long as the reproduced sounds of those frequencies sound together like a chord sound.

Further, for the purpose of making the warning sound more noticeable to the pedestrian and, for reducing the electric consumption, the warning sound in the present embodiment is generated intermittently with an interval of 60 ms as shown in FIG. 5, the warning sound generation cycle is not limited to such cycle.

(Low-frequency Cut Filter 24)

In the present embodiment, the lowest frequency of the warning sound generated by the parametric speaker 1 is set to be higher than the frequency of the warning sound generated by the vehicular horn 3.

More practically, the low pitch sound frequency, such as 500 Hz in the present embodiment, is reproduced by the vehicular horn 3 but is not reproduced by the parametric speaker 1.

Further in detail, when the warning sound in the present embodiment is a composite sound having frequencies of 500 Hz, 1 kHz, 2 kHz, and 4 kHz, it is configured that the parametric speaker 1 does not generate the low pitch sound frequency of 500 Hz, which can be reproduced by the vehicular horn 3, and that the parametric speaker 1 generates only the frequencies of 1 kHz, 2 kHz, and 4 kHz.

Therefore, the low-frequency cut filter 24 in the present embodiment is provided, for removing the low frequency of 500 Hz of the warning sound signal from the warning sound generation unit 23 and for passing only the other frequencies of 1 kHz, 2 kHz, and 4 kHz to the supersonic wave modulation unit 25.

The low-frequency cut filter 24 may be provided as a sound filter of the CR circuit having CR (i.e., capacitor and a resistor) or the CL circuit having CL (i.e., a capacitor and inductance), or the like.

(Supersonic Wave Modulation Unit 25)

The supersonic wave modulation unit 25 modulates the output from the warning sound generation unit 23, which has the frequency of 500 Hz removed by the low-frequency cut filter 24, into a supersonic wave.

In the present embodiment, the supersonic wave modulation unit 25 uses amplitude modulation (i.e., AM modulation) for modulating the warning sound signal into a signal of amplitude change (i.e., an increase and decrease change of the voltage) in the supersonic wave frequency (e.g., 25 kHz). More practically, the supersonic wave modulation unit 25 outputs the supersonic wave signal that is realized by the analog signal that has the “+” voltage and the “−” voltage alternating with each other.

Further, the supersonic wave modulation unit 25 may use other modulation techniques, such as pulse width modulation (PWM), which modulates the warning sound signal into a signal of width change (i.e., width of the pulse generation time) in the supersonic wave frequency (e.g., 25 kHz).

(Supersonic Wave Drive Amplifier 26)

The supersonic wave drive amplifier 26 drives each of the piezoelectric speakers 21 based on the supersonic wave signal that is modulated by the supersonic wave modulation unit 25. That is, the supersonic wave drive amplifier 26 generates the supersonic wave, which is formed by the modulation of the warning sound signal, by controlling the applied voltage for (i.e., charging and discharging conditions of) each of the piezoelectric speakers 21.

In the present embodiment, the supersonic wave drive amplifier 26 may be a push-pull type analog amplifier (for example, a class B amplifier) that applies to each of the piezoelectric speakers 21 the increase and decrease of the voltage of the supersonic wave signal that is outputted from the supersonic wave modulation unit 25.

In such manner,
when the warning sound generation unit 23 generates a frequency of 1 kHz, the parametric speaker 1 reproduces a frequency of 1 kHz,
when the warning sound generation unit 23 generates a frequency of 2 kHz, the parametric speaker 1 reproduces a frequency of 2 kHz, and
when the warning sound generation unit 23 generates a frequency of 4 kHz, the parametric speaker 1 reproduces a frequency of 4 kHz.

Further, because the above operations are performed within a cycle of 60 ms, each of those single sound frequencies is heard substantially at the same time by the human ear. In other words, the warning sound from the parametric speaker 1 sounds like a chord sound that is composed of the frequencies of 1 kHz, 2 kHz and 4 kHz, similar to the warning sound from the vehicular horn 3.

The supersonic wave drive amplifier 26 has a gain controller (e.g., a volume controller), and the gain controller is used to set a predetermined sound pressure level of the warning sound from the supersonic speaker 5 at a certain distance from the vehicle in front of the vehicle. That is, for example, the sound pressure of the warning sound from the supersonic speaker 5 may be set to 50 dB, at a position of 10 meters from the vehicle (see FIG. 4A).

Further, in the above example, “a warning sound signal” is generated by the warning sound generation unit 23 that is shared with the vehicular horn 3.

In contrast, a dedicated warning sound generation unit may be provided for the parametric speaker 1, for generating a warning sound signal as a composite sine wave signal of multiple frequency components (for example, a composite sound of 1 kHz, 2 kHz and 4 kHz). Further, if the dedicated warning sound generation unit 23 is provided to the parametric speaker 1, the low-frequency cut filter 24 may be omitted from the vehicle (approach) warning apparatus.

(Signal Process Unit 27)

The signal process unit 27 generates a warning sound when the signal process unit 27 receives a warning sound operation signal, which is an operation instruction signal, from, for example, an electronic control unit (ECU) of the vehicle.

The ECU may generate the warning sound operation signal in the following situations:

(i) The ECU generates the warning sound operation signal and provides the signal to the signal process unit 27 when the vehicle is in a certain driving condition, which requires the output of the warning sound, such as the vehicle is traveling at a speed of 20 km/h or slower.

OR

(ii) The ECU generates the warning sound operation signal and provides the signal to the signal process unit 27 when existence of a human being is confirmed by a human recognition system (not illustrated) in a traveling direction of the vehicle.

After receiving the warning sound operation signal from the ECU, the signal process unit 27 operates:

(i) the parametric speaker 1 to output the warning sound from the supersonic speaker 5, and

(ii) the horn drive amplifier 4 to output the warning sound from the vehicular horn 3, which is operated by the horn drive amplifier 4 as a dynamic speaker.

(Operation of the Vehicle (Approach) Warning Apparatus)

When the warning sound operation signal is provided for the signal process unit 27 from the ECU, a supersonic wave, which is inaudible, is generated by modulating the warning sound signal, which has frequencies of 1 kHz, 2 kHz, and 4 kHz cyclically generated in order within 60 ms, and is emitted from the supersonic speaker 5 under the control of the signal process unit 27 toward a travel direction of the vehicle.

As the supersonic wave travels in the air, the supersonic wave having a short wave length is warped by, for example, a viscosity of the air or the like. That is, the edge of the supersonic wave dulls, due to the attenuation of the wave energy. As a result, an amplitude component in the supersonic wave is self-demodulated during the travel of the supersonic wave, thereby reproducing the warning sound that has a sound wave frequencies of 1 kHz, 2 kHz and 4 kHz and reaches the ear of a person at the same time. The warning sound produced by the supersonic wave is audible at a position that is distant from the vehicle.

Further, when the warning sound operation signal is provided for the signal process unit 27 from the ECU, a warning sound signal, which has frequencies of 500 Hz, 1 kHz, 2 kHz, and 4 kHz cyclically generated in order within 60 ms, is emitted from the vehicular horn 3 under control of the signal process unit 27.

As a result, a warning sound having frequencies of 500 Hz, 1 kHz, 2 kHz and 4 kHz that reaches the ears of an individual at the same time is generated in an immediate surrounding area of the vehicle.

(Effect 1 of the Present Embodiment)

Because the vehicle (approach) warning apparatus is operated with the electric power of the vehicle, the consumption of power needs to be reduced. Such requirement is especially great when the apparatus is installed in a electric vehicle, a hybrid vehicle, or the like.

A dynamic speaker is conventionally driven by an alternating signal that alternates between the “+”/“−” voltage (i.e., an electric current) in a form of a sine wave. More practically, as a power amplifier, which drives the dynamic speaker, a push-pull type analog amplifier (i.e., a class B amplifier or the like) is conventionally used.

When the vehicular horn 3 is operated as a dynamic speaker and is driven by an alternating signal, a counter electromotive force is caused in the coil 2 of the vehicular horn 3 at a point of alternation of the coil-applied voltage from the “+” voltage to the “−” voltage, and from the “−” voltage to the “+” voltage. Such counter electromotive force in the coil 2 results in the loss of electric power, thereby causing the increase of the electricity consumption in the power amplifier.

The vehicle (approach) warning apparatus generates and outputs the warning sound, as described above, from the parametric speaker 1 and the vehicular horn 3 toward an outside of the vehicle, and the warning sound from the vehicular horn 3 is generated by driving the vehicular horn 3 with the rectangular wave signal having the voltage of 0 V or more.

In such manner, the coil 2 in the vehicular horn 3 does not have the “+”/“−” voltage alternating with each other, thereby resolving a problem in which the counter electromotive force is generated in the coil 2 due to the alternating voltages. Therefore, by avoiding the counter electromotive force in the coil 2, the loss of the electric power in the power amplifier is prevented, thus the power consumption of the power amplifier is reduced.

More practically, by using a digital amplifier as the horn drive amplifier 4 for driving the vehicular horn 3, the smaller volume and the lightweight packaging of the power amplifier, as well as the improvement of the install ability of the amplifier in the vehicle, are achieved at the same time.

(Effect 2 of the Present Embodiment)

Further, the counter electromotive force in the coil 2 affects the magnetic field generated by the coil 2, thereby causing a change of sound tone that is generated by the vehicular horn 3, when the vehicular horn 3 is operated as a dynamic speaker.

Further, when the warning sound including the low pitch sound is generated by the parametric speaker 1, the tone of the warning sound from the parametric speaker 1 deteriorates as the frequency of the low pitch sound lowers, due to the influence of the higher harmonic waves of the low pitch sound.

Accordingly, because the problematic influence of the counter electromotive force over the magnetic force of the coil 2 is prevented in the above-described manner, the change of tone in the sound from the vehicular horn 3 due to the counter electromotive force is also prevented.

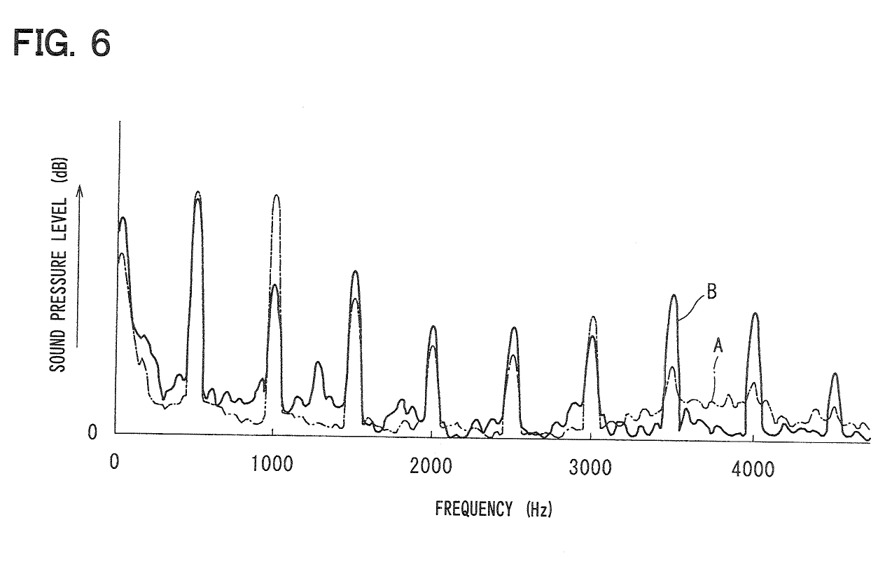

Such an advantage is explained with reference to FIG. 6 more concretely. The frequency characteristics of the reproduced sound by driving the vehicular horn 3 according to a signal having frequencies of 500 Hz and its overtones in a sine wave form of 0 V or more are shown by a dashed line “A”. The frequency characteristics of the reproduced sound by driving the vehicular horn 3 according to a signal having frequencies of 500 Hz and its overtones in a rectangular wave form of 0 V or more are shown by a sold line “B” in FIG. 6.

Accordingly, from comparison between the line “A” and line “B”, the sound reproduction capability of the vehicular horn 3 is improved when the vehicular horn 3 is driven by a signal having the rectangular wave form, and such improvement is more recognizable on the high pitch sound side, thus preventing the deterioration of the tone in the sound from the vehicular horn 3.

(Effect 3 of the Present Embodiment)

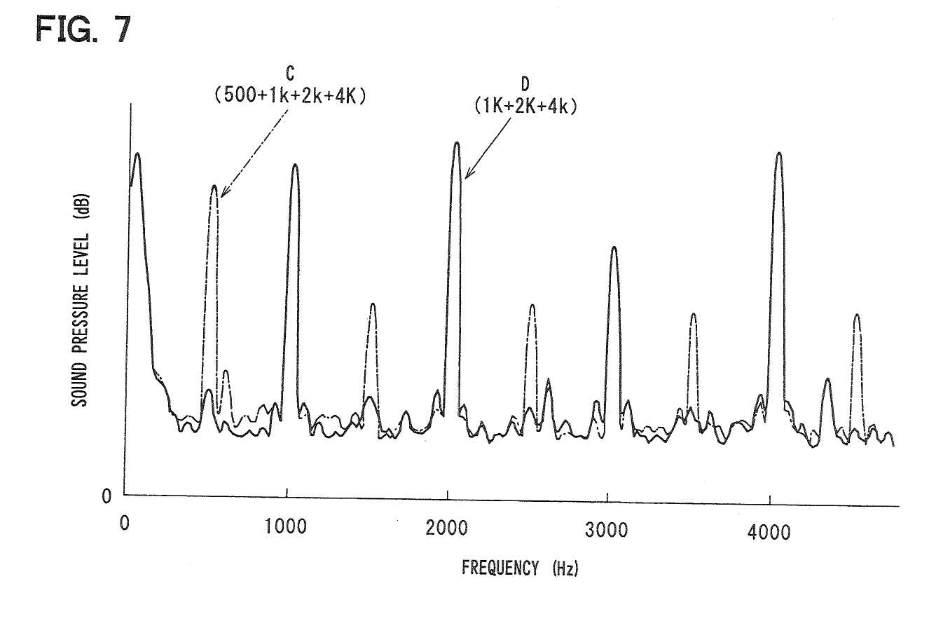

With reference to FIG. 7, when a composite sound having wave frequencies of 500 Hz, 1 kHz, 2 kHz, and 4 kHz is generated as a warning sound, such composite sound may be generated by both the parametric speaker 1 and vehicular horn 3 that is being operated as a dynamic speaker.

In this case, the supersonic speaker 5 in the parametric speaker 1 may emit supersonic waves that are generated by supersonic modulation of audible sounds having frequencies of 500 Hz, 1 kHz, 2 kHz, and 4 kHz. After the output from the supersonic speaker 5, a modulated component of the emitted supersonic wave, which is an inaudible sound, is self-demodulated during the transmission in the air, to be heard as the warning sound having the frequencies of 500 Hz, 1 kHz, 2 kHz, and 4 kHz at a distant position from the supersonic speaker 5.

However, in an actual reproduced sound from the parametric speaker 1, overtones of 500 Hz, which can be of 1 kHz, 1.5 kHz, 2 kHz, 2.5 kHz and the like, are included, as shown by a dashed line “C” of FIG. 7.

These overtones having the frequencies of 1.5 kHz, 2.5 kHz and the like are not the sounds intended to be reproduced. That is, the overtones of 500 Hz (i.e., low pitch sound frequency) not intended to be reproduced deteriorates the tones of the warning sound output from the parametric speaker 1.

The vehicle (approach) warning apparatus of the present embodiment is configured such that the parametric speaker 1 does not output the low pitch sound of 500 Hz, which can be reproduced by the vehicular horn 3.

In such manner, the influence of higher harmonic waves that have frequencies of 1.5 kHz, 2.5 kHz and the like on the reproduced sound from the parametric speaker 1 is prevented, as shown in FIG. 7 by a solid line D, thereby preventing the deterioration of the tone in the sound from the parametric speaker 1.

(Effect 4 of the Present Embodiment)

The vehicle (approach) warning apparatus of the present embodiment uses a composite sound having multiple frequencies (i.e., a chord sound) as a warning sound as stated above. Further, in the present embodiment, the multiple frequency components in the composite sound is divided into multiple single sound frequencies, and the rectangular wave signals of the divided single sound frequencies are configured to be cyclically generated in certain order within a cycle of 60 ms, which is a predetermined short cycle.

In such manner, even if the vehicular horn 3 is driven by the rectangular wave signals, the sound from the vehicular horn 3, which is a composite sound having frequencies of 500 Hz, 1 kHz, 2 kHz and 4 kHz, can be heard substantially at the same time by the human ear. That is, the composite sound reaches the human ear as a chord sound, even when the vehicular horn 3 is driven by the rectangular wave signal.

Therefore, the above technique enables the vehicular horn 3 to generate the warning sound having multiple frequency components, such as a chord sound or the like, even when the vehicular horn 3 is driven by the rectangular wave signal.

(Effect 5 of the Present Embodiment)

The vehicle (approach) warning apparatus of the present embodiment generates a warning sound that radiates outwards from the vehicle from the parametric speaker 1 and the vehicular horn 3, thereby exerting the following advantageous effects.

(a) In a short-distance range (for example, 0 to 5 meters) in front of the vehicle, the warning sound from the parametric speaker 1 and the warning sound from the vehicular horn 3 are composed to reproduce a high sound pressure warning sound.

Therefore, when the vehicle is in a short-distance range from a pedestrian, the warning sound of high sound pressure is provided for the pedestrian, thereby notifying the pedestrian of the existence of the vehicle more securely.

(b) In a long-distance range (for example, 5 to 10 meters) in front of the vehicle, the warning sound from the parametric speaker 1 is provided for the pedestrian.

Therefore, even when the distance of the pedestrian from the vehicle is long, a warning sound is provided for the pedestrian, and the existence of the vehicle is notified to the pedestrian who is far from the vehicle.

(c) Because the sound from the parametric speaker 1 is generated as a result of self-demodulation of the supersonic wave when the supersonic wave travels a certain distance from the vehicle through the air, such self-demodulated sound is hardly audible for the occupant (e.g., a driver) of the vehicle.

In other words, even though the warning sound from the parametric speaker 1 and the warning sound from the vehicular horn 3 are composed with each other to generate a warning sound having a high sound pressure, the vehicle occupant is prevented from such high sound pressure, due to the inaudibility of the warning sound from the parametric speaker 1.

The use of the dynamic speaker as a horn of the vehicle reduces production cost as well as improving the install ability of the apparatus.

Further, “the vehicular horn” is a generic term for the warning device in a vehicle, thereby including a device that is not equipped with a horn shape member (i.e., a trumpet member having its word origin in a “bugle”), such as an electro-magnetic type vehicular horn.

In an example of the above embodiment, a warning sound signal from the vehicular horn 3 and a warning sound signal from the parametric speaker 1 are generated in common by only one warning sound generation unit 23. However, the vehicle (approach) warning apparatus may have a dedicated warning sound generation unit for the vehicular horn and a dedicated warning sound generation unit for the parametric speaker separately. In such manner, a warning sound signal suitable for the vehicular horn 3 and a warning sound signal suitable for the parametric speaker 1 may be made separately.

In an example of the above embodiment, an analog amplifier is used as the supersonic wave drive amplifier 26. However, a digital amplifier which is capable of charging and discharging the piezoelectric speaker 21 may also be used.

In an example of the above embodiment, a warning sound signal is generated as an analog signal by the warning sound generation unit 23. However, a warning sound signal may be generated as a digital signal by the warning sound generation unit 23, if the supersonic wave drive amplifier 26 is implemented as a digital amplifier. In such manner, an analog-to-digital converter (AD converter), which converts an analog signal into a digital signal, in the digital amplifier can be omitted.

In an example of the above embodiment, a swirl horn 14 (i.e., a trumpet member) is used as the vehicular horn 3. However, the vehicular horn 3 may be a horn having a different shape that generates a warning sound or an excitation horn sound by vibration of the vibration board 9, such as a planar, disk shape horn or the like.

Further, it may be desirable for the supersonic speaker 5 to be attached directly to the vehicular horn 3 by using a stay, a metal part or the like, even if the vehicular horn 3 does not have the swirl horn 14.

Based on the foregoing, a warning sound is generated by a dynamic speaker, and a warning sound is also generated by a parametric speaker.

Further, the parametric speaker is a device that emits an audible sound warning sound after supersonic modulation of the wave form signal. The supersonic wave, which is an inaudible sound, is emitted from the supersonic speaker and has a modulated sound component that is to be self-demodulated during the transmission in the air, thereby generating an audible warning sound at a distant position from the vehicle.

In the above-described manner of using both of the dynamic speaker and the parametric speaker, the warning sound is generated at the long-distance range by the parametric speaker. Therefore, the sound pressure of the dynamic speaker can be lowered, and the above-described problem of the unnecessarily great sound pressure of the warning sound for the vehicle occupant can be prevented.

In consideration of the foregoing, the vehicle (approach) warning apparatus in the present embodiment is a device that notifies the existence and approach of the vehicle by generating the warning sound, such as a single sound, a chord sound, a music piece, a simulated engine sound or the like. The vehicle (approach) warning apparatus may include a parametric speaker 1 that outputs a supersonic wave that fadiates outward from the vehicle by modulating the warning sound to the supersonic wave, and an electro-magnetic type vehicular horn 3, which is operated as a dynamic speaker, to output the warning sound of the audio sound range by the change of a magnetic force that is induced by the voltage applied to a coil 2.

When the warning sound is generated by the vehicular horn 3, the vehicular horn 3 is driven by the rectangular wave signal of 0 V or more. In such manner, the vehicular horn 3 can generate a warning sound without causing the counter electromotive force in the coil 2 of the vehicular horn 3.

More practically, a digital amplifier (e.g., a class D amplifier) generating a drive signal of the rectangular wave shape is used as a horn drive amplifier 4 (i.e., a power amplifier) for driving the vehicular horn 3. By using the digital amplifier, the consumed electricity by the horn drive amplifier 4 can be reduced to an extremely low level, and the volume and weight of the horn drive amplifier 4 can be reduced.

Although the present disclosure has been fully described in connection with preferred embodiment thereof with reference to the accompanying drawings, it is to be noted that various changes and modifications will become apparent to those skilled in the art.

Changes, modifications, and summarized schemes are to be understood as being within the scope of the present disclosure as defined by appended claims.

What is claimed is:

1. A vehicle approach warning apparatus for notifying the presence of a vehicle, the vehicle approach warning apparatus comprising:
a parametric speaker for outputting a supersonic wave that radiates outward from the vehicle, the supersonic wave is generated by performing a supersonic modulation on a warning sound; and
a dynamic speaker for outputting an audible-frequency-range warning sound that radiates outward from the vehicle by changing a magnetic field of a coil based on a change of an electric current applied to the coil, wherein the dynamic speaker is driven by a rectangular wave signal of at least 0 V.

2. The vehicle approach warning apparatus of claim 1, wherein
a lowest frequency of the warning sound generated by the dynamic speaker is configured to be higher than a lowest frequency of the warning sound generated by the parametric speaker.

3. The vehicle approach warning apparatus of claim 1, wherein,
when the dynamic speaker is configured to generate a composite sound having multiple frequencies as the warning sound, the composite sound is divided into multiple single sound frequencies, and
each of the single sound frequencies of the composite sound is cyclically generated in a certain order in a predetermined short cycle.

4. The vehicle approach warning apparatus of claim 1, wherein the dynamic speaker includes:
an interrupter that connects and disconnects an electricity supply circuit of the coil when a self-excitation voltage equal to or greater than a threshold voltage is provided as a current for the coil to generate a magnetic force;
a movable iron core that is driven by the magnetic force from the coil; and
a vibration board that is coupled to the movable iron core, and the dynamic speaker is an electro-magnetic type vehicular horn that generates an alarm sound when a horn switch is operated by a vehicle occupant and the electricity for causing a self-excitation voltage is intermittently provided for the coil through the interrupter, thereby vibrating the vibration board together with the movable iron core.
